(19) United States
(12) Patent Application Publication
(10) Pub. No.: US 2016/0128163 A1
(43) Pub. Date: May 5, 2016

(54) LIGHT EMITTING DEVICE DRIVING CIRCUIT AND METHOD THEREOF

(71) Applicants: Kinpo Electronics, Inc., New Taipei City (TW); Cal-Comp Electronics & Communications Company Limited, New Taipei City (TW)

(72) Inventors: Chun-Chieh Chang, New Taipei City (TW); Yueh-Feng Lin, New Taipei City (TW); Yu-Ta Lin, New Taipei City (TW)

(21) Appl. No.: 14/571,051

(22) Filed: Dec. 15, 2014

(30) Foreign Application Priority Data
Oct. 30, 2014 (TW) 103137595

(51) Int. Cl. H05B 37/02

(52) U.S. Cl. CPC H05B 37/0227

(57) ABSTRACT

A light emitting device driving circuit and a method thereof are provided. The light emitting device driving circuit includes a frequency detection circuit and a frequency adjustment circuit. The frequency detection circuit is configured to detect a light source frequency of a light emitting device to provide at least one detection frequency signal. The frequency adjustment circuit adjusts the light source frequency of the light emitting device according to the detection frequency signal and a plurality of preset flicker frequencies.

### CROSS-REFERENCE TO RELATED APPLICATION

This application claims the priority benefit of Taiwan application serial no. 103137595, filed on Oct. 30, 2014. The entirety of the above-mentioned patent application is hereby incorporated by reference herein and made a part of this specification.

### BACKGROUND OF THE INVENTION

1. Field of the Invention

The invention relates to a driving circuit, and more particularly to a light emitting device driving circuit and a method thereof.

2. Description of Related Art

In recent years, light emitting diodes (LEDs) have been gradually adopted as light emitting devices to generate illuminating light sources in a variety of lighting equipments or luminaires in the living environment. LEDs have advantages such as energy saving, long life, environmental protection and small sizes, and therefore have been widely used by the public as light sources in various devices, e.g., lighting equipments, display equipments and mobile electronic products, and become primary illuminating light sources having functions of energy saving and environmental protection.

In the case that images are captured in an environment where the illuminating light source is generated by the lighting equipments or luminaires, electronic devices having a function of capturing images usually capture images by using photosensitive elements such as charge-coupled devices (CCDs) or complementary metal-oxide semiconductors (CMOSs) to capture the illuminating light source which enters into the devices through lens and accordingly generate displaying images.

However, if operation frequency of an electronic device which captures images does not match light source frequency of a lighting equipment or luminaire, flickering phenomenon may occur on the captured displaying images, flickering would occur on screens and thereby undermining quality of captured images.

### SUMMARY OF THE INVENTION

The invention provides a light emitting device driving circuit and a method thereof, which may actively detect a light source frequency of a light emitting device in an environment and carry out adjustments accordingly, so as to prevent an issue of flickering phenomena from occurring on display screens when images are captured.

The light emitting device driving circuit of the invention includes a frequency detection circuit and a frequency adjustment circuit, wherein the frequency detection circuit is configured to detect a light source frequency of a light emitting device to provide at least one detection frequency signal. The frequency adjustment circuit is coupled to the frequency detection circuit and the light emitting device, and adjusts the light source frequency of the light emitting device according to the detection frequency signal and a plurality of preset flicker frequencies.

In an embodiment of the invention, the frequency adjustment circuit includes a storage unit. A frequency comparison table is stored in the storage unit. The plurality of preset flicker frequencies is recorded in the frequency comparison table, wherein the frequency adjustment circuit determines whether the light source frequency of the light emitting device is equivalent to any one of the preset flicker frequencies. When the light source frequency of the light emitting device is equivalent to any one of the preset flicker frequencies, the frequency adjustment circuit adjusts the light source frequency of the light emitting device to a frequency which is different from the preset flicker frequencies.

In an embodiment of the invention, the frequency detection circuit includes a light source detection circuit and an amplifier circuit. The light source detection circuit detects the light source frequency of the light emitting device to provide at least one detection frequency signal. The amplifier circuit is coupled to the light source detection circuit and amplifies the detection frequency signal, and provides the amplified detection frequency signal to the frequency adjustment circuit.

In an embodiment of the invention, the light source detection circuit includes a first photodiode, a first resistor, a second resistor, a second photodiode, a third resistor and a fourth resistor. A cathode of the first photodiode is coupled to a driving voltage. A first terminal of the first resistor is coupled to an anode of the first photodiode. A first terminal of the second resistor is coupled to a second terminal of the first resistor, and a second terminal of the second resistor is coupled to a ground potential. The first photodiode detects a light source frequency which belongs to a first light wave band, so as to generate a first detection frequency signal at a common contact of the first resistor and the second resistor. A cathode of the second photodiode is coupled to a driving voltage. A first terminal of the third resistor is coupled to an anode of the second photodiode. A first terminal of the fourth resistor is coupled to a second terminal of the third resistor, and a second terminal of the fourth resistor is coupled to a ground potential. The second photodiode detects a light source frequency which belongs to a second light wave band, so as to generate a second detection frequency signal at a common contact of the third resistor and the fourth resistor.

In an embodiment of the invention, the amplifier circuit includes a NPN-type bipolar junction transistor (BJT), a second NPN-type bipolar junction transistor, a fifth resistor, a sixth resistor and a seventh resistor. A base of the first NPN-type bipolar junction transistor is coupled to the second terminal of the first resistor, and a collector of the first NPN-type bipolar junction transistor provides the amplified first detection frequency signal. A base of the second NPN-type bipolar junction transistor is coupled to the second terminal of the third resistor, and a collector of the first NPN-type bipolar junction transistor provides the amplified second detection frequency signal. A first terminal of the fifth resistor is coupled to the collector of the first NPN-type bipolar junction transistor, and a second terminal of the fifth resistor is coupled to a common mode voltage. A first terminal of the sixth resistor is coupled to the collector of the second NPN-type bipolar junction transistor, and a second terminal of the sixth resistor is coupled to a common mode voltage. A first terminal of the seventh resistor is coupled to an emitter of the first NPN-type bipolar junction transistor and an emitter of the second NPN-type bipolar junction transistor, and a second terminal of the seventh resistor is coupled to a ground potential.

In an embodiment of the invention, the frequency adjustment circuit includes a control chip. The control chip has a power pin, a ground pin, a first input pin, a second input pin and an output pin. The power pin receives the common mode voltage which is required for operations. The ground pin is coupled to a ground potential. A first input pin receives a first detection frequency signal. A second input pin receives a second detection frequency signal. The output pin outputs a driving signal.

In an embodiment of the invention, the frequency adjustment circuit further includes a capacitor. The capacitor is coupled between the power pin and the ground potential.

The light emitting device driving method of the invention includes the following steps: detecting a light source frequency of a light emitting device to provide at least one detection frequency signal; and adjusting the light source frequency of the light emitting device according to the detection frequency signal and a plurality of preset flicker frequencies.

In an embodiment of the invention, the step of adjusting the light source frequency of the light emitting device according to the at least one detection frequency signal includes to determine whether the light source frequency of the light emitting device is equivalent to any one of the preset flicker frequencies. When the light source frequency of the light emitting device is equivalent to any one of the preset flicker frequencies, the light source frequency of the light emitting device is adjusted to a frequency which is different from the preset flicker frequencies recorded in a frequency comparison table.

In an embodiment of the invention, the light emitting device driving method further includes amplifying the detection frequency signal.

In light of the foregoing, the embodiment of the invention adjusts the light source frequency accordingly by detecting the light source frequency of the light emitting device. Accordingly, the light source frequency of the light emitting device may match an operation frequency when the electronic device captures images, so as to minimize flickering phenomena on display screens, thereby enhancing quality of the captured images.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a light emitting device driving circuit according to an embodiment of the invention.

FIG. 2 is a schematic view illustrating a frequency detection circuit according to an embodiment of the invention.

FIG. 3 is a schematic view illustrating a light emitting device driving circuit according to an embodiment of the invention.

FIG. 4 is a schematic flowchart illustrating a light emitting device driving method according to an embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

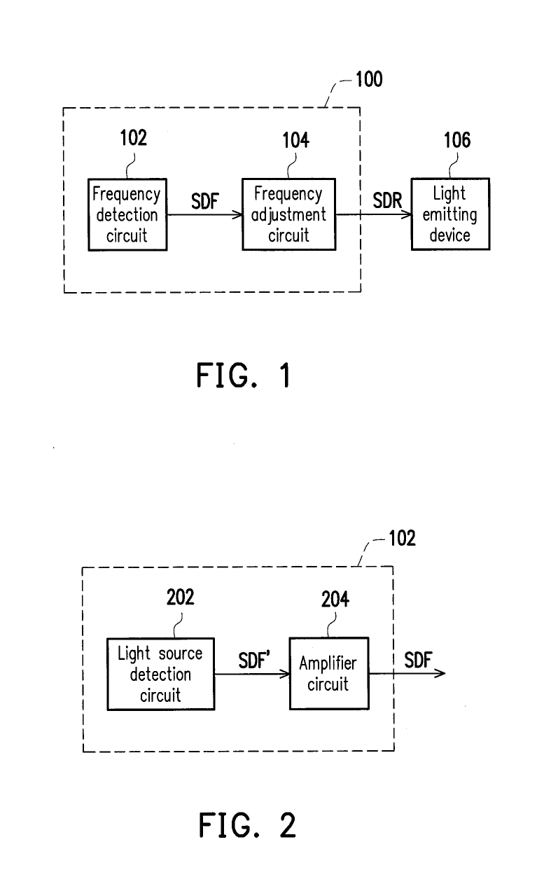

FIG. 1 is a schematic view illustrating a light emitting device driving circuit according to an embodiment of the invention. A light emitting device driving circuit 100 is configured to drive a light emitting device 106 to generate an illuminating light source. The light emitting device driving circuit 100 includes a frequency detection circuit 102 and a frequency adjustment circuit 104. The frequency detection circuit 102 is configured to detect a light source frequency of the light emitting device 106 to provide a detection frequency signal SDF. The frequency adjustment circuit 104 is coupled to the frequency detection circuit 102 and the light emitting device 106. The frequency adjustment circuit 104 outputs a driving signal SDR to the light emitting device 106 according to the detection frequency signal SDF and a plurality of preset flicker frequencies, so as to adjust the light source frequency of the light emitting device 106, wherein the driving signal SDR may be, for example, a pulse-width-modulation signal (PWM signal). The light emitting device 106 may adjust the light source frequency according to a duty cycle of the PWM signal, but the invention should not be construed as limited to the embodiments set forth herein.

More specifically, in the present embodiment, the frequency adjustment circuit 104 includes a storage unit (not shown). A frequency comparison table is stored in the storage unit, and the plurality of preset flicker frequencies are recorded in the frequency comparison table. The preset flicker frequencies are light source frequencies of flickering phenomena which occur on display screens when electronic devices in various specifications capture images in an environment having an illuminating light source. In other words, when the light source frequency is equivalent to any one of the present flicker frequencies which is recorded in the frequency comparison table, the captured images flicker. Accordingly, the frequency adjustment circuit 104 may determine whether the light source frequency of the light emitting device 106 is equivalent to any one of the preset flicker frequencies. When the light source frequency of the light emitting device 106 is equivalent to any one of the preset flicker frequencies, the frequency adjustment circuit 104 may adopt the driving signal SDR to adjust the light source frequency of the light emitting device 106 to a frequency which is different from the preset flicker frequencies recorded in the frequency comparison table. For example, the light source frequency of the light emitting device 106 is increased so as to prevent the captured images from flickering.

FIG. 2 is a schematic view illustrating a frequency detection circuit according to an embodiment of the invention. With reference to FIG. 2, specifically, the frequency detection circuit 102 may be, for example, shown in FIG. 2 and include a light source detection circuit 202 and an amplifier circuit 204. The light source detection circuit 204 detects the light source frequency of the light emitting device 106 to provide a corresponding detection frequency signal SDF'. The amplifier circuit 204 is coupled to the light source detection circuit 202. The amplifier circuit 204 may amplify the detection frequency signal SDF' to the detection frequency signal SDF, and provide the amplified detection frequency signal SDF to the frequency adjustment circuit 104, such that the frequency adjustment circuit 104 may adjust a light source of the light emitting device 106 accordingly.

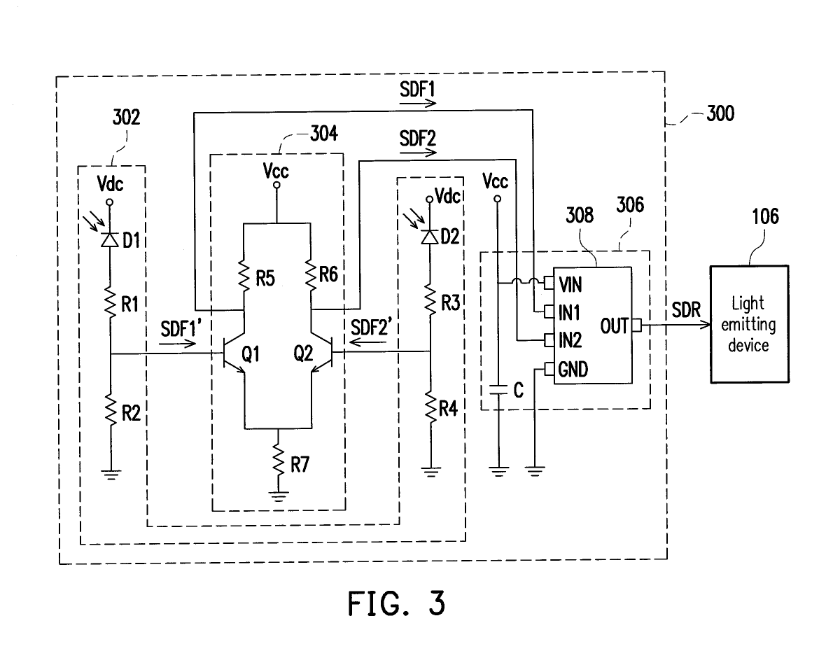

FIG. 3 is a schematic view illustrating a light emitting device driving circuit according to an embodiment of the invention. With reference to FIG. 3, a light emitting device driving circuit 300 is configured to drive the light emitting device 106 to generate an illuminating light source. The light emitting device driving circuit 300 includes a frequency detection circuit (including a light source detection circuit 302 and an amplifier circuit 304) and a frequency adjustment circuit 306 (including a control chip 308 and a capacitor C). In the present embodiment, the light emitting device driving circuit 300 generates corresponding detection frequency signals SDF1 and SDF2 according to two light source frequencies having different light wave bands, and adjusts the light source frequency of the light emitting device 106 accordingly, but the invention should not be construed as limited to the embodiments set forth herein. In another embodiment, a frequency detection circuit may also detect a light source frequency having one or more than three light wave bands so as to adjust the light source frequency of the light emitting device 106.

Specifically, the light source detection circuit 302 includes photodiodes D1 and D2, and resistors R1-R4. A cathode of the photodiode D1 is coupled to a driving voltage Vdc. A first terminal of the resistor R1 is coupled to an anode of the photodiode D1. A first terminal of the resistor R2 is coupled to a second terminal of the resistor R1, and a second terminal of the resistor R2 is coupled to a ground potential (e.g., 0v). In operations, the photodiode D1 may detect a light source frequency which falls within a range of a light wave band B1, and generate a corresponding current accordingly after photoelectric conversion is carried out, so as to generate a detection frequency signal SDF1′ at a common contact of the resistor R1 and the resistor R2.

A cathode of the photodiode D2 is coupled to the driving voltage Vdc. A first terminal of the resistor R3 is coupled to an anode of the photodiode D2. A first terminal of the resistor R4 is coupled to a second terminal of the resistor R3, and a second terminal of the resistor R4 is coupled to a ground potential. In operations, the photodiode D2 may detect a light source frequency which falls within a range of a light wave band B2, and generate a corresponding current accordingly after photoelectric conversion is carried out, so as to generate a detection frequency signal SDF2′ at a common contact of the resistor R3 and the resistor R4, wherein the light wave band B1 and the light wave band B2 are frequency bands of different ranges. For example, ranges of the frequency bands of the light wave band B1 and the light wave band B2 may be complementary, but the invention should not be construed as limited to the embodiments set forth herein.

The amplifier 304 includes a NPN-type bipolar junction transistors (BJTs) Q1 and Q2, and resistors R5-R7. A base of the NPN-type bipolar junction transistor Q1 is coupled to the second terminal of the resistor R1. A base of the NPN-type bipolar junction transistor Q2 is coupled to the second terminal of the resistor R3. A first terminal of the resistor R5 is coupled to a collector of the NPN-type bipolar junction transistor Q1, and a second terminal of the resistor R5 is coupled to a common mode voltage Vcc. A first terminal of the resistor R6 is coupled to a collector of the NPN-type bipolar junction transistor Q2, and a second terminal of the resistor R6 is coupled to the common mode voltage Vcc. A first terminal of the resistor R7 is coupled to an emitter of the first NPN-type bipolar junction transistor Q1 and an emitter of the second NPN-type bipolar junction transistor Q2, and a second terminal of the resistor R7 is coupled to a ground potential.

On operations, the NPN-type bipolar junction transistor Q1 may, by the base thereof, receive the detection frequency signal SDF1′ which corresponds to the light wave band B1, and generate an amplified detection frequency signal SDF1 at the collector of the NPN-type bipolar junction transistor Q1. Likewise, the NPN-type bipolar junction transistor Q2 may, by the base thereof, receive the detection frequency signal SDF2′ which corresponds to the light wave band B2, and generate an amplified detection frequency signal SDF2 at the collector of the NPN-type bipolar junction transistor Q2. Accordingly, the detection frequency signal SDF1 and the detection frequency signal SDF2 which respectively correspond to the light wave band B1 and the light wave band B2 may be provided to the frequency adjustment circuit 306.

The frequency adjustment circuit 306 includes the control chip 308 and the capacitor C. The control chip 308 has a power pin VIN, a ground pin GND, an input pin IN1, an input pin IN2 and an output pin OUT. The power pin VIN receives the common mode voltage Vcc which is required for an operation of the control chip 308, and the capacitor C is coupled between the power pin VIN and a ground potential so as to stabilize the operation of the control chip 308. The ground pin GND is coupled to a ground potential. The input pin IN1 receives the detection frequency signal SDF1 which is provided by the amplifier circuit 304. The input pin IN2 receives the detection frequency signal SDF2 which is provided by the amplifier circuit 304. The output pin OUT outputs the driving signal SDR to the light emitting device 106, so as to adjust the light source frequency of the light emitting device 106 according to the detection frequency signal SDF1 and the detection frequency signal SDF2. Specifically, the control chip 308 detects the light source frequency of the light emitting device 106 by the detection frequency signal SDF1 received by the input pin IN1 and the detection frequency signal SDF2 received by the input pin IN 2. When the light source frequency of the light emitting device 106 is equivalent to any one of the preset flicker frequencies which is recorded in the frequency comparison table (the frequency comparison table, for example, is stored in the storage unit of the control chip 308), the control chip 308 may output the driving signal SDR to the light emitting device 106 by the output pin OUT. In addition, the light source frequency of the light emitting device 106 is adjusted to a frequency which is different from the present flicker frequencies recorded in the frequency comparison table by adopted the driving signal SDR, so as to prevent the captured images from flickering. For example, if the present flicker frequency is a frequency of 120 Hz or lower and the light source frequency of the light emitting device 106 is lower than 120 Hz, the control chip 308 may adjust the light source frequency of the light emitting device 106 to a frequency of 120 Hz or more so as to minimize flickering phenomena on display screens.

In practical applications, in the light emitting device driving circuit 300 as shown in FIG. 3, a resistance of the resistors R1-R4 may be arranged as 0.47Ω, a resistance of the resistors R5-R6 may be arranged as 1 KΩ, a resistance of the resistor R7 may be arranged as 1 KΩ, and a capacitance of the capacitor C may be arranged as 4.7 nF. Of course, in the light emitting device driving circuit 300 as shown in FIG. 3, the resistances of the resistors R1-R7 and the capacitance of the capacitor C may be adjusted based on actual requirements for designs and applications.

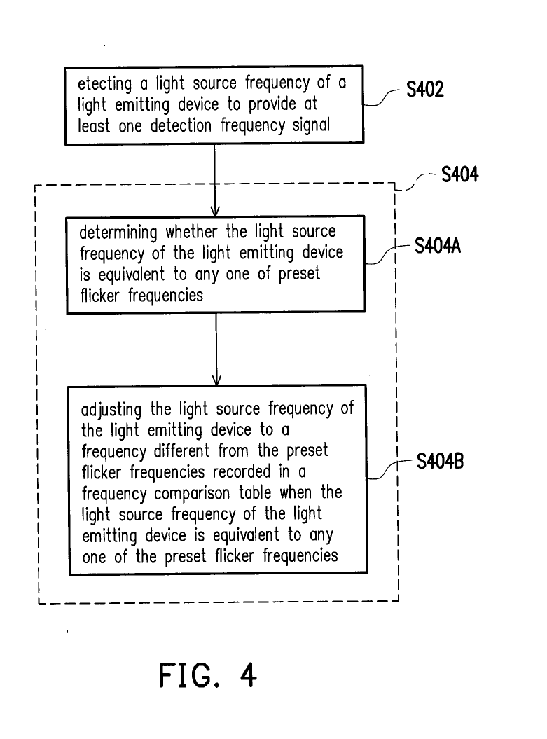

FIG. 4 is a schematic flowchart illustrating a light emitting device driving method according to an embodiment of the invention. It is concluded from the above embodiments that a light emitting device driving method at least includes the following steps. First, a light source frequency of a light emitting device is detected to provide at least one detection frequency signal (Step 402). Next, the light source frequency of the light emitting device is adjusted according to the detection frequency signal and a plurality of preset flicker frequencies (Step 404). In some embodiments, the detection frequency signal may also be amplified first before the light source frequency of the light emitting device is adjusted according to the detection frequency signal and the plurality of preset flicker frequencies. Specifically, a method of adjusting the light emitting device according to the detection frequency signal may be, for example, to determine whether the light source frequency of the light emitting device is equivalent to any one of the preset flicker frequencies (Step 404A). When the light source frequency of the light emitting device is equivalent to any one of the preset flicker frequencies, the light source frequency of the light emitting device is adjusted to a frequency which is different from the preset flicker frequencies recorded in the frequency comparison table (Step 404B), so as to prevent the captured images from flickering.

In summary, the embodiment of the invention determines whether the light source frequency of the light emitting device matches an operation frequency of an electronic device by detecting the light source frequency of the light emitting device, and adjusts the light source frequency accordingly. By doing so, flickering phenomena on display screens may be minimized when the electronic device captures images, thereby enhancing quality of the captured images.

Although the invention has been disclosed with reference to the aforesaid embodiments, they are not intended to limit the invention. It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light emitting device driving circuit, suitable for driving a light emitting device, the light emitting device driving circuit comprising:
a frequency detection circuit, configured to detect a light source frequency of the light emitting device to provide at least one detection frequency signal; and
a frequency adjustment circuit, coupled to the frequency detection circuit and the light emitting device, adjusting the light source frequency of the light emitting device according to the at least one detection frequency signal and a plurality of preset flicker frequencies.

2. The light emitting device driving circuit as claimed in claim 1, wherein the frequency adjustment circuit comprises:
a storage unit, storing a frequency comparison table, the frequency comparison table recording the preset flicker frequencies,
wherein the frequency adjustment circuit determines whether the light source frequency of the light emitting device is equivalent to any one of the preset flicker frequencies, when the light source frequency of the light emitting device is equivalent to any one of the preset flicker frequencies, the frequency adjustment circuit adjusts the light source frequency of the light emitting device to a frequency different from the preset flicker frequencies.

3. The light emitting device driving circuit as claimed in claim 1, wherein the frequency detection circuit comprises:
a light source detection circuit, detecting the light source frequency of the light emitting device to provide the at least one detection frequency signal; andan amplifier circuit, coupled to the light source detection circuit, amplifying the at least one detection frequency signal, and providing the amplified at least one detection frequency signal to the frequency adjustment circuit.

4. The light emitting device driving circuit as claimed in claim 3, wherein the light source detection circuit comprises:
a first photodiode, a cathode of the first photodiode being coupled to a driving voltage;
a first resistor, a first terminal of the first resistor being coupled to an anode of the first photodiode;
a second resistor, a first terminal of the second resistor being coupled to a second terminal of the first resistor, and a second terminal of the second resistor being coupled to a ground potential, the first photodiode detecting a light source frequency belonging to a first light wave band to generate a first detection frequency signal at a common contact of the first resistor and the second resistor;
a second photodiode, a cathode of the second photodiode being coupled to the driving voltage;
a third resistor, a first terminal of the third resistor being coupled to an anode of the second photodiode; and
a fourth resistor, a first terminal of the fourth resistor being coupled to a second terminal of the third resistor, and a second terminal of the fourth resistor being coupled to the ground potential, the second photodiode detecting a light source frequency belonging to a second light wave band to generate a second detection frequency signal at a common contact of the third resistor and the fourth resistor.

5. The light emitting device driving circuit as claimed in claim 4, wherein the amplifier circuit comprises:
a first NPN-type bipolar junction transistor (BJT), a base of the first NPN-type bipolar junction transistor being coupled to the second terminal of the first resistor, and a collector of the first NPN-type bipolar junction transistor providing the amplified first detection frequency signal;
a second NPN-type bipolar junction transistor, a base of the second NPN-type bipolar junction transistor being coupled to the second terminal of the third resistor, and a collector of the second NPN-type bipolar junction transistor providing the amplified second detection frequency signal;
a fifth resistor, a first terminal of the fifth resistor being coupled to the collector of the first NPN-type bipolar junction transistor, and a second terminal of the fifth resistor being coupled to a common mode voltage;
a sixth resistor, a first terminal of the sixth resistor being coupled to the collector of the second NPN-type bipolar junction transistor, and a second terminal of the sixth resistor being coupled to the common mode voltage; and
a seventh resistor, a first terminal of the seventh resistor being coupled to an emitter of the first NPN-type bipolar junction transistor and an emitter of the second NPN-type bipolar junction transistor, and a second terminal of the seventh resistor being coupled to the ground potential.

6. The light emitting device driving circuit as claimed in claim 4, wherein the frequency adjustment circuit comprises a control chip, the control chip has a power pin, a ground pin, a first input pin, a second input pin and an output pin, the power pin receives a common mode voltage required for an operation, the ground pin is coupled to the ground potential, the first input pin receives the first detection frequency signal, the second input pin receives the second detection frequency signal, the output pin outputs a driving signal.

7. The light emitting device driving circuit as claimed in claim 6, wherein the frequency adjustment circuit further comprises a capacitor being coupled between the power pin and the ground potential.

8. A light emitting device driving method, suitable for driving a light emitting device, the light emitting device driving method comprising steps of:
detecting a light source frequency of the light emitting device to provide at least one detection frequency signal; and
adjusting the light source frequency of the light emitting device according to the at least one detection frequency signal and a plurality of preset flicker frequencies.

9. The light emitting device driving method as claimed in claim 8, wherein the step of adjusting the light source frequency of the light emitting device according to the at least one detection frequency signal and the plurality of present flicker frequencies comprises:
determining whether the light source frequency of the light emitting device is equivalent to any one of the preset flicker frequencies; andadjusting the light source frequency of the light emitting device to a frequency different from the preset flicker frequencies recorded in a frequency comparison table when the light source frequency of the light emitting device is equivalent to any one of the preset flicker frequencies.

10. The light emitting device driving method as claimed in claim 8, further comprising:
amplifying the at least one detection frequency signal.
